(19) United States
(12) Patent Application Publication
(10) Pub. No.: US 2022/0012421 A1
(43) Pub. Date: Jan. 13, 2022

(54) EXTRACTING CONTENT FROM AS DOCUMENT USING VISUAL INFORMATION

(71) Applicant: International Business Machines Corporation, Armonk, NY (US)

(72) Inventors: Zhong Fang Yuan, XI'AN (CN); Zhuo Cai, Beijing (CN); Tong Liu, Ki'an (CN); Yu Pan, Shanghai (CN); Xiang Yu Yang, Xi'an (CN); Dong Qin, Shaan Xi (CN)

(21) Appl. No.: 16/927,512

(22) Filed: Jul. 13, 2020

(51) Int. Cl. G06F 40/205; G06F 40/151

(52) U.S. Cl. CPC G06F 40/205; G06F 40/151

(57) ABSTRACT

An aspect of the present invention discloses a method for extracting content from a document. The method includes one or more processors identifying a visual anchor corresponding to a text element depicted in a first document utilizing an edge detection analysis. The method further includes determining edge coordinates of the text element depicted in the first document. The method further includes determining text at a leading edge of the text element depicted in the first document and text at a trailing edge of the text element depicted in the first document, based on the determined edge coordinates. The method further includes extracting a complete version of the text element depicted in the first document, from a plain text version of the first document, utilizing the determined text at the leading edge of the text element and the determined text at the trailing edge of the text element.

### BACKGROUND OF THE INVENTION

The present invention relates generally to the field of text analytics, and more particularly to extracting information from a document.

Information extraction (IE), information retrieval (IR) is the task of automatically extracting structured information from unstructured and/or semi-structured machine-readable documents and other electronically represented sources. In many instances, IE and IR includes processing human language texts by means of natural language processing (NLP). Recent activities in multimedia document processing, such as automatic annotation and content extraction out of images/audio/video/documents, are additional examples of information extraction. The process of text analytics includes linguistic, statistical, and machine learning techniques that model and structure the information content of textual sources. For example, for business intelligence, exploratory data analysis, research, data investigation, etc. The term text analytics also describes that application of text analytics to respond to business problems, whether independently or in conjunction with query and analysis of fielded, numerical data.

Image analysis is the extraction of meaningful information from images; mainly from digital images by means of digital image processing techniques. Image analysis tasks can be as simple as reading bar coded tags or as sophisticated as identifying individuals. Digital Image Analysis or Computer Image Analysis is when a computer or electrical device automatically studies an image to obtain useful information from the image. Examples of image analysis techniques in different fields include: 2D and 3D object recognition, image segmentation, motion detection, video analysis, optical flow, edge detection, medical scan analysis, etc.).

Edge detection includes a variety of mathematical methods that aim at identifying points in a digital image at which the image brightness changes sharply or, more formally, has discontinuities. The points at which image brightness changes sharply are typically organized into a set of curved line segments, termed edges. The same problem of finding discontinuities in one-dimensional signals is known as step detection and the problem of finding signal discontinuities over time is known as change detection. Edge detection is a fundamental tool in image processing, machine vision and computer vision, particularly in the areas of feature detection and feature extraction.

### SUMMARY

Aspects of the present invention disclose a method, computer program product, and system for extracting content from a document. The method includes one or more processors identifying a visual anchor corresponding to a text element depicted in a first document utilizing an edge detection analysis on the first document. The method further includes one or more processors determining edge coordinates of the text element depicted in the first document. The method further includes one or more processors determining text at a leading edge of the text element depicted in the first document and text at a trailing edge of the text element depicted in the first document, based on the determined edge coordinates. The method further includes one or more processors extracting a complete version of the text element depicted in the first document, from a plain text version of the first document, utilizing the determined text at the leading edge of the text element and the determined text at the trailing edge of the text element.

### BRIEF DESCRIPTION OF THE DRAWINGS

FIG. 1 is a functional block diagram of a data processing environment, in accordance with an embodiment of the present invention.

FIG. 2 is a flowchart depicting operational steps of a program for extracting content from a document, in accordance with embodiments of the present invention.

FIG. 3 depicts a block diagram of components of a computing system representative of the computing device and server of FIG. 1, in accordance with an embodiment of the present invention.

### DETAILED DESCRIPTION

Embodiments of the present invention allow for extracting content (e.g., text) from a document utilizing visual anchors in the document. Embodiments of the present invention identify a visual anchor (i.e., a defined visual indication, such as highlighting, italicizing, underline, coloring, etc.) in a document. Embodiments of the present invention also utilize edge detection to identify and record edge coordinates of the visual anchor in the document, then determine (e.g., utilizing image analytics) text that is present at the leading and trailing edge coordinates. Further embodiments identify a text file of the document (e.g., a plain text file version of the document) and extract a text element corresponding to the recorded edge coordinates from the document. For example, embodiments utilize the determined text that is present at the leading and trailing edge coordinates to extract the entire text element that is constrained by the visual anchor.

Some embodiments of the present invention recognize that traditional text extraction methods generally convert documents from a fixed-layout format to plain text and then use text processing (e.g., natural language processing (NLP), entity recognition, etc.) to extract content of elements of the text document. However, because the form and content of the document element items can be variable, embodiments of the present invention recognize that traditional extraction methods and the deep learning method represented by named entity recognition requires a large amount of labeled data. In addition, embodiments of the present invention recognize that for many types of niche information, there is an increased difficulty in accurately and effectively recognizing certain niche domains of information, due to a lack of training data.

Various embodiments of the present invention recognize the difficulty in extracting text elements in a document accurately without too much training data in document intelligence analysis. Accordingly, embodiments of the present invention provide advantages that include a process for identifying and extracting text elements from a document based on identified visual information, without requiring specific domain training and knowledge that directly corresponds to content in the document.

Implementation of embodiments of the invention may take a variety of forms, and exemplary implementation details are discussed subsequently with reference to the Figures.

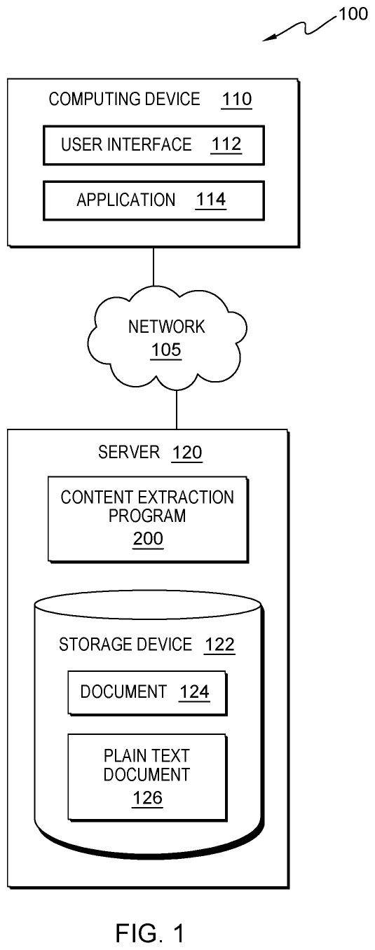

The present invention will now be described in detail with reference to the Figures. FIG. 1 is a functional block diagram illustrating a distributed data processing environment, generally designated 100, in accordance with one embodiment of the present invention. FIG. 1 provides only an illustration of one implementation and does not imply any limitations with regard to the environments in which different embodiments may be implemented. Many modifications to the depicted environment may be made by those skilled in the art without departing from the scope of the invention as recited by the claims.

An embodiment of data processing environment 100 includes computing device 110 and server 120, interconnected over network 105. In an example embodiment, server 120 analyzes image and text to extract text elements from a document (e.g., utilizing content extraction program 200), in accordance with embodiments of the present invention. Network 105 can be, for example, a local area network (LAN), a telecommunications network, a wide area network (WAN), such as the Internet, or any combination of the three, and include wired, wireless, or fiber optic connections. In general, network 105 can be any combination of connections and protocols that will support communications between computing device 110 and server 120, in accordance with embodiments of the present invention. In various embodiments, network 105 facilitates communication among a plurality of networked computing devices (e.g., computing device 110 and other computing devices (not shown)), corresponding users (e.g., an individual computing device 110), and corresponding network-accessible services (e.g., server 120).

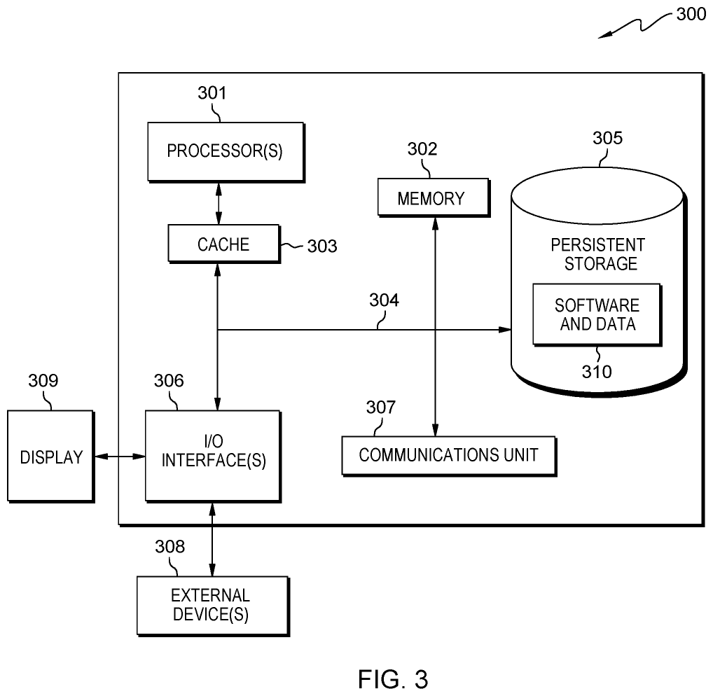

In various embodiments of the present invention, computing device 110 may be a workstation, personal computer, personal digital assistant, mobile phone, or any other device capable of executing computer readable program instructions, in accordance with embodiments of the present invention. In general, computing device 110 is representative of any electronic device or combination of electronic devices capable of executing computer readable program instructions. Computing device 110 may include components as depicted and described in further detail with respect to FIG. 3, in accordance with embodiments of the present invention. In an example embodiment, computing device 110 is a smartphone. In another example embodiment, client device 110 is a personal computer or workstation.

Computing device 110 includes user interface 112 and application 114. User interface 112 is a program that provides an interface between a user of computing device 110 and a plurality of applications that reside on the computing device (e.g., application 114). A user interface, such as user interface 112, refers to the information (such as graphic, text, and sound) that a program presents to a user, and the control sequences the user employs to control the program. A variety of types of user interfaces exist. In one embodiment, user interface 112 is a graphical user interface. A graphical user interface (GUI) is a type of user interface that allows users to interact with electronic devices, such as a computer keyboard and mouse, through graphical icons and visual indicators, such as secondary notation, as opposed to text-based interfaces, typed command labels, or text navigation. In computing, GUIs were introduced in reaction to the perceived steep learning curve of command-line interfaces which require commands to be typed on the keyboard. The actions in GUIs are often performed through direct manipulation of the graphical elements. In another embodiment, user interface 112 is a script or application programming interface (API).

Application 114 can be representative of one or more applications (e.g., an application suite) that operate on computing device 110. In an example embodiment, application 114 is a client-side application of a service or enterprise associated with server 120. In another example embodiment, application 114 is a web browser that an individual utilizing computing device 110 utilizes (e.g., via user interface 112) to access and provide information over network 105. For example, a user of client device 110 provides input to user interface 112 to identity a document (e.g., a contract) to transmit to server 120 over network 105, for analysis and information/test extraction.

In another example, the user of computing device 110 can utilize application 114 to annotate (e.g., apply highlighting, underlining, italicize, etc.) a document (e.g., document 124), prior to transmission of the document to server 120 for analysis, in accordance with embodiments of the present invention. In other aspects of the present invention, application 114 can be representative of one or more applications that provide additional functionality on computing device 110 (e.g., camera, messaging, etc.), in accordance with various aspects of the present invention.

In various embodiments of the present invention, the user of computing device 110 registers with server 120 (e.g., via a corresponding application). For example, the user completes a registration process, provides information, and authorizes the collection and analysis (i.e., opts-in) of relevant data on at least computing device 110, by server 120 (e.g., user profile information, user contact information, authentication information, user preferences, or types of information, for server 120 utilize with content extraction program 200). In various embodiments, a user can opt-in or opt-out of certain categories of data collection. For example, the user can opt-in to provide all requested information, a subset of requested information, or no information.

In example embodiments, server 120 can be a desktop computer, a computer server, or any other computer systems, known in the art. In certain embodiments, server 120 represents computer systems utilizing clustered computers and components (e.g., database server computers, application server computers, etc.) that act as a single pool of seamless resources when accessed by elements of data processing environment 100 (e.g., client device 110). In general, server 120 is representative of any electronic device or combination of electronic devices capable of executing computer readable program instructions. Server 120 may include components as depicted and described in further detail with respect to FIG. 3, in accordance with embodiments of the present invention.

Server 120 includes content extraction program 200 and storage device 122, which includes document 124 and plain text document 126. In various embodiments, server 120 can be a server computer system that provides support (e.g., via content extraction program 200) to an enterprise environment, in accordance with embodiments of the present invention. In additional embodiments, server 120 can provide support to users submitting requests for information and analysis (e.g., via executing content extraction program 200 on identified/received documents). For example, server 120 utilizes content extraction program 200 to analyze documents (such as document 124) that server 120 receives or are accessible over network 105. In additional embodiments, server 120 includes capabilities to store derived information (e.g., in storage device 122), in accordance with various embodiments of the present invention. In additional embodiments, server 120 can access text and image analysis services (not shown) over network 105, to perform image and/or text analysis, in accordance with embodiments of the present invention.

In example embodiments, content extraction program 200 extracts content from a document, in accordance with embodiments of the present invention. In various embodiments, content extraction program 200 identifies a visual anchor (i.e., a defined visual indication, such as highlighting, underline, italicizing, coloring, etc.) in a document (e.g., document 124). For example, content extraction program 200 can utilize edge detection to identify and record edge coordinates of the visual anchor in the document, then determine (e.g., utilizing image analytics) text that is present at the leading and trailing edge coordinates. Further, content extraction program 200 identifies a text file of the document (e.g., a plain text file version of document 124, such as plain text document 126) and extract a text element corresponding to the recorded edge coordinates from the document.

In another embodiment, server 120 utilizes storage device 122 to store documents (e.g., document 124, plain text document 126, etc.), information associated with documents and corresponding analyses (e.g., indications of visual anchors, extracted content/text, etc.), user-provided information (e.g., user profile data, user preferences, encrypted user information, user data authorizations, etc.), and other data that content extraction program 200 can utilize, in accordance with embodiments of the present invention. In various embodiments, storage device 122 includes defined preferences for content extraction program 200 to utilize in accordance with embodiments of the present invention. For example, storage device 122 stores definitions of visual anchors for content extraction program 200 to utilize in the process of identifying visual anchors in a document, such as underlining, bolding, highlighting, italicizing, text color, special characters, particular characters and/or phrases, images or other non-textual content, or other identifiable visual information.

Storage device 122 can be implemented with any type of storage device, for example, persistent storage 305, which is capable of storing data that may be accessed and utilized by server 120, such as a database server, a hard disk drive, or a flash memory. In other embodiments, storage device 122 can represent multiple storage devices and collections of data within server 120. In various embodiments, server 120 can utilize storage device 122 to store data that the user of computing device 110 authorizes server 120 to gather and store.

In example embodiments, document 124 is representative of a document (e.g., a contract, terms of service, etc.) that content extraction program 200 can analyze, in accordance with various embodiments of the present invention. For example, document 124 is a fixed layout document (e.g., image, .pdf, etc.). In another example, document 124 is not a plain text document file. In various embodiments, document 124 includes visual information, such as visual anchors, in the text of document 124. For example, document 124 includes text elements that are marked with visual anchors, such as underlining, bolding, highlighting, text coloring, etc. In another embodiment, document 124 can be a document that is marked up (e.g., highlighting provided by a user of computing device 110) with one or more visual anchors.

In one embodiment, a user of computing device 110 sends document 124 to server 120 for analysis (using content extraction program 200). In another embodiment, server 120 can retrieve document 124 from a data source (e.g., a repository, a website, etc.). For example, a user of computing device 110 identifies a terms of service document on a website and requests server 120 to analyze the terms of service document. Accordingly, server 120 can retrieve the terms of service document and store an instance as document 124.

In example embodiments, plain text document 126 is a plain text version of document 124 that content extraction program 200 can analyze, in accordance with various embodiments of the present invention. In one embodiment, server 120 can convert document 124 into plain text and store as plain text document 126 or utilize a network-accessible service (over network 105) to convert document 124 to plain text, and then store plain text document 126 (in storage device 122). In another embodiment, server 120 can receive plain text document 126 from an external source to utilize in accordance with embodiments of the present invention.

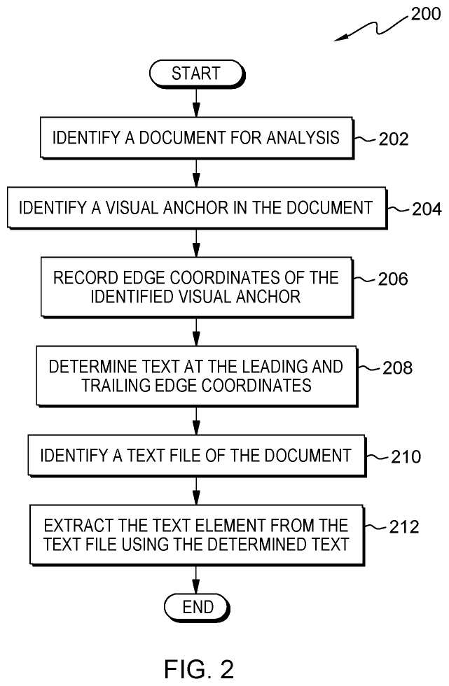

FIG. 2 is a flowchart depicting operational steps of content extraction program 200, a program for extracting content from a document, in accordance with embodiments of the present invention. In one embodiment, content extraction program 200 initiates in response to an indication of a document (e.g., receiving a document, identification of a terms of service document, etc.) to analyze.

In step 202, content extraction program 200 identifies a document for analysis. In one embodiment, content extraction program 200 receives document 124, or an indication to analyze document 124 (e.g., from a user of computing device 110). In various embodiments, content extraction program 200 can identify document 124 from a set of documents indicated for analysis.

In an example embodiment, content extraction program 200 identifies a version of document 124 in the native format of document 124 (i.e., without requiring conversion to a plain text version). In an example scenario, document 124 is a contract, such as a terms of service agreement, that is in a fixed layout (e.g., an image, etc.). In other scenarios, document 124 can be any form of document that is identified for analysis by content extraction program 200, in accordance with embodiments of the present invention.

In step 204, content extraction program 200 identifies a visual anchor in the document. In one embodiment, content extraction program 200 analyzes document 124 utilizing available document analysis techniques (e.g., utilizing techniques and/or applications located on server 120 and/or accessible via network 105), such as image analysis, edge detection, object recognition, etc. In an example, document 124 is a document with a fixed layout (i.e., not plain text formatting). In this example, content extraction program 200 can utilize edge detection, or other image analysis and/or feature detection techniques, to identify a visual anchor within document 124.

In another aspect, content extraction program 200 utilizes a defined set of preferences (e.g., system preferences, user-defined preferences, content-specific preferences, etc.) to determine visual information in document 124 that is representative of a visual anchor. In example embodiments, content extraction program 200 scans document 124 for a defined visual anchor. For example, content extraction program 200 utilizes a defined set of visual anchors that includes one or more of underlining, bolding, highlighting, text coloring, and other forms of visually identifiable characteristics in a document. In another scenario, content extraction program 200 can utilize a defined hierarchy of visual anchors, i.e., search for underlining first, then search for highlighting, etc.

In one example, content extraction program 200 searches document 124 for a visual anchor of underlined text. In this example, content extraction program 200 identifies an underlined text element that states, “Return Timeframe: You can decide to initiate a return for a website order within thirty days from the receipt of the parcel shipment.” Accordingly, content extraction program 200 identifies the underlining visual anchor that encompasses the underlined text element. In additional examples, content extraction program 200 can identify a first visual anchor, then proceed to identify additional visual anchors in document 124 (i.e., parallel processing of visual anchors through the processing steps of content extraction program 200).

In an alternate example embodiment, content extraction program 200 can identify a first visual anchor, then complete processing with respect to the identified first visual anchor (i.e., complete the processing steps of FIG. 2), and then perform a second iteration (of the processing steps of content extraction program 200 depicted in FIG. 2) to identify and process a second visual anchor (if applicable).

In step 206, content extraction program 200 records edge coordinates of the identified visual anchor. In one embodiment, content extraction program 200 determines and records (x, y) coordinates of the leading and trailing edge of the identified visual anchor in document 124. In various embodiments, through edge detection, content extraction program 200 determines edge coordinates of visual anchors in document 124 (e.g., x, y) coordinates in an image or fixed layout document) and stores the determined edge coordinates in storage device 122, associated with document 124.

In the previously discussed example, content extraction program 200 identifies an underlined text element that states, “Return Timeframe: You can decide to initiate a return for a website order within thirty days from the receipt of the parcel shipment” (in step 204). In this example, content extraction program 200 determines the edge coordinates of the leading edge (i.e., the start) of the identified visual anchor to be (x1, y1) and the edge coordinates of the trailing edge (i.e., the end) of the identified visual anchor to be (x2, y2). Accordingly, content extraction program 200 records the edge coordinates and can store the coordinates in storage device 122.

In step 208, content extraction program 200 determines text at the leading and trailing edge coordinates. In one embodiment, content extraction program 200 utilizes image and visual analytics techniques to determine text at the recoded coordinates (from step 206) the leading edge and the trailing edge. In example embodiments, content extraction program 200 utilizes optical character recognition (OCR) to derive text from the edge coordinates of an image, such as document 124. In various embodiments, content extraction program 200 can identify one or more words (or other sets of characters) at the leading and trailing edge coordinates (recorded in step 206). For example, content extraction program 200 can reference user preferences and/or system preferences to determine a number of words (or characters) to determine at the leading and trailing edges. In various embodiments, content extraction program 200 can designate the determined text at the leading and trailing edge coordinates as the anchor words of the text element.

In the previously discussed example, content extraction program 200 determined and recorded leading and trailing edge coordinates of (x1, y1) and (x2, y2), respectively (from step 206). Content extraction program 200 can then utilize OCR to determine a word at the leading edge (i.e., the first word of the text element) and a word at the trailing edge (i.e., the last word of the text element). In this example, content extraction program 200 determines “Return” to be the word present at (x1, y1) and determines “shipment” to be the word present at (x2, y2). In other example embodiments, content extraction program 200 can identify more than one word at the respective leading and trailing edge, based on defined preferences and/or in the case or repetitive wording in document 124.

In step 210, content extraction program 200 identifies a text file of the document. In one embodiment, content extraction program 200 identifies plain text document 126, which is a plain text version of document 124. In an example embodiment, content extraction program 200 can receive plain text document 126 (e.g., from a user of computing device 110). In another example embodiment, content extraction program 200 can identify plain text document 126 on a network-accessible resource or repository (not shown). In a further embodiment, content extraction program 200 can convert document 124 to a plain text version, creating plain text document 126.

In step 212, content extraction program 200 extracts the text element from the text file using the determined text. In one embodiment, content extraction program 200 extracts the whole text element from plain text document 126 utilizing the determined text at the leading and trailing edge coordinates (in step 208), and any intervening text between the respective instances of determined text. For example, content extraction program 200 can utilize the anchor words of the text element (determined in step 208) to extract the whole text element from plain text document 126 (e.g., to extract a whole element from a contract, or terms of service document).

In the previously discussed example, content extraction program 200 determined “Return” to be the word present at (x1, y1) and determined “shipment” to be the word present at (x2, y2). Content extraction program 200 can then analyze plain text document 126 to determine the text element that is encompassed by the leading word of “Return” and the trailing word of “shipment.” In this example, content extraction program 200, utilizing the anchor words (from step 208), extracts the complete text element of “Return Timeframe: You can decide to initiate a return for a website order within thirty days from the receipt of the parcel shipment.”

In an alternate embodiment, content extraction program 200 can also utilize other characteristics derived from document 126 (e.g., from edge detection) to identify the correct text element in plain text document 126, such as a number of words in the text element, other words in proximity, etc. In further embodiments, content extraction program 200 can store the extracted contract element (e.g., in storage device 122, associated with document 124 and/or plain text document 126). In an additional embodiment, content extraction program 200 can export the extracted contract elements (e.g., to computing device 110, or other indicated users and/or devices not shown).

In various embodiments, content extraction program 200 can loop and iterate, and/or concurrently operate, for multiple text elements in document 124, based on visual anchors in document 124, as necessary. In an additional embodiment, content extraction program 200 can execute different iterations for different types or categories of visual anchors (e.g., italics, highlighting, coloring, etc.).

Embodiments of the present invention recognize the difficulty in extracting text elements in a document accurately without too much training data in document intelligence analysis. Accordingly, embodiments of the present invention provide advantages that include a process for identifying and extracting text elements from a document based on identified visual information, without requiring specific domain training and knowledge that directly corresponds to content in the document. Through processing of content extraction program 200, embodiments of the present invention derive text elements from a document (e.g., a contract), without requiring domain knowledge specific to the document (i.e., content extraction program 200 does not need large-scale pre-training data). Content extraction program 200 also provides advantages of extracting text elements that cannot be extracted utilizing traditional text processing methods (e.g., NLP, etc.).

FIG. 3 depicts computer system 300, which is representative of computing device 110 and server 120, in accordance with an illustrative embodiment of the present invention. It should be appreciated that FIG. 3 provides only an illustration of one implementation and does not imply any limitations with regard to the environments in which different embodiments may be implemented. Many modifications to the depicted environment may be made. Computer system 300 includes processor(s) 301, cache 303, memory 302, persistent storage 305, communications unit 307, input/output (I/O) interface(s) 306, and communications fabric 304. Communications fabric 304 provides communications between cache 303, memory 302, persistent storage 305, communications unit 307, and input/output (I/O) interface(s) 306. Communications fabric 304 can be implemented with any architecture designed for passing data and/or control information between processors (such as microprocessors, communications and network processors, etc.), system memory, peripheral devices, and any other hardware components within a system. For example, communications fabric 304 can be implemented with one or more buses or a crossbar switch.

Memory 302 and persistent storage 305 are computer readable storage media. In this embodiment, memory 302 includes random access memory (RAM). In general, memory 302 can include any suitable volatile or non-volatile computer readable storage media. Cache 303 is a fast memory that enhances the performance of processor(s) 301 by holding recently accessed data, and data near recently accessed data, from memory 302.

Program instructions and data (e.g., software and data 310) used to practice embodiments of the present invention may be stored in persistent storage 305 and in memory 302 for execution by one or more of the respective processor(s) 301 via cache 303. In an embodiment, persistent storage 305 includes a magnetic hard disk drive. Alternatively, or in addition to a magnetic hard disk drive, persistent storage 305 can include a solid state hard drive, a semiconductor storage device, a read-only memory (ROM), an erasable programmable read-only memory (EPROM), a flash memory, or any other computer readable storage media that is capable of storing program instructions or digital information.

The media used by persistent storage 305 may also be removable. For example, a removable hard drive may be used for persistent storage 305. Other examples include optical and magnetic disks, thumb drives, and smart cards that are inserted into a drive for transfer onto another computer readable storage medium that is also part of persistent storage 305. Software and data 310 can be stored in persistent storage 305 for access and/or execution by one or more of the respective processor(s) 301 via cache 303. With respect to computing device 110, software and data 310 are representative of user interface 112 and application 114. With respect to server 120, software and data 310 includes content extraction program 200, document 124, plain text document 126.

Communications unit 307, in these examples, provides for communications with other data processing systems or devices. In these examples, communications unit 307 includes one or more network interface cards. Communications unit 307 may provide communications through the use of either or both physical and wireless communications links. Program instructions and data (e.g., software and data 310) used to practice embodiments of the present invention may be downloaded to persistent storage 305 through communications unit 307.

I/O interface(s) 306 allows for input and output of data with other devices that may be connected to each computer system. For example, I/O interface(s) 306 may provide a connection to external device(s) 308, such as a keyboard, a keypad, a touch screen, and/or some other suitable input device. External device(s) 308 can also include portable computer readable storage media, such as, for example, thumb drives, portable optical or magnetic disks, and memory cards. Program instructions and data (e.g., software and data 310) used to practice embodiments of the present invention can be stored on such portable computer readable storage media and can be loaded onto persistent storage 305 via I/O interface(s) 306. I/O interface(s) 306 also connect to display 309.

Display 309 provides a mechanism to display data to a user and may be, for example, a computer monitor.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be accomplished as one step, executed concurrently, substantially concurrently, in a partially or wholly temporally overlapping manner, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

What is claimed is:

1. A method comprising:
identifying, by one or more processors, a document having a fixed layout version and a plain text version, wherein the fixed layout version is an image file and the plain text version is a text file;
identifying, by one or more processors, a visual anchor corresponding to a text element depicted in the fixed layout version of the document utilizing an edge detection analysis;
determining, by one or more processors, edge coordinates of the text element depicted in the fixed layout version of the document;
determining, by one or more processors, text at a leading edge of the text element depicted in the fixed layout version of the document and text at a trailing edge of the text element depicted in the fixed layout version of the document, based on the determined edge coordinates; and
extracting, by one or more processors, a complete version of the text element depicted in the fixed layout version of the document, from the plain text version of the document, utilizing the determined text at the leading edge of the text element and the determined text at the trailing edge of the text element, wherein the complete version of the text element includes the determined text at the leading edge of the text element, the determined text at the trailing edge of the text element, and one or more intervening words between the determined text at the leading edge of the text element and the determined text at the trailing edge of the text element.

2. The method of claim 1, wherein the visual anchor is a visual depiction of information in the fixed layout version of the document, selected from the group consisting of: one or more particular characters, one or more particular phrases, and one or more images.

3. (canceled)

4. The method of claim 1, wherein determining the text at the leading edge of the text element depicted in the fixed layout version of the document and the text at the trailing edge of the text element depicted in the fixed layout version of the document, based on the determined edge coordinates, further comprises:
identifying, by one or more processors, a first word at edge coordinates of the text element that correspond to the leading edge of the text element, utilizing optical character recognition (OCR) analysis; and
identifying, by one or more processors, a second word at edge coordinates of the text element that correspond to the trailing edge of the text element, utilizing OCR analysis.

5. (canceled)

6. The method of claim 1, wherein determining the text at the leading edge of the text element depicted in the fixed layout version of the document and the text at the trailing edge of the text element depicted in the fixed layout version of the document, based on the determined edge coordinates, further comprises:
identifying, by one or more processors, at least two words at edge coordinates of the text element that correspond to the leading edge of the text element, utilizing optical character recognition (OCR) analysis; and
identifying, by one or more processors, at least two words at edge coordinates of the text element that correspond to the trailing edge of the text element, utilizing OCR analysis.

7. The method of claim 1, further comprising:
converting, by one or more processors, the fixed layout version of the document into the plain text version of the document.

8. A computer program product comprising:
one or more computer readable storage media and program instructions stored on the one or more computer readable storage media, the stored program instructions comprising:
program instructions to identify a document having a fixed layout version and a plain text version, wherein the fixed layout version is an image file and the plain text version is a text file;
program instructions to identify a visual anchor corresponding to a text element depicted in the fixed layout version of the document utilizing an edge detection analysis;
program instructions to determine edge coordinates of the text element depicted in the fixed layout version of the document;
program instructions to determine text at a leading edge of the text element depicted in the fixed layout version of the document and text at a trailing edge of the text element depicted in the fixed layout version of the document, based on the determined edge coordinates; and
program instructions to extract a complete version of the text element depicted in the fixed layout version of the document, from the plain text version of the document, utilizing the determined text at the leading edge of the text element and the determined text at the trailing edge of the text element, wherein the complete version of the text element includes the determined text at the leading edge of the text element, the determined text at the trailing edge of the text element, and one or more intervening words between the determined text at the leading edge of the text element and the determined text at the trailing edge of the text element.

9. The computer program product of claim 8, wherein the visual anchor is a visual depiction of information in the fixed layout version of the document, selected from the group consisting of: one or more particular characters, one or more particular phrases, and one or more images.

10. (canceled)

11. The computer program product of claim 8, wherein the program instructions to determine the text at the leading edge of the text element depicted in the fixed layout version of the document and the text at the trailing edge of the text element depicted in the fixed layout version of the document, based on the determined edge coordinates, further comprise:
program instructions to identify a first word at edge coordinates of the text element that correspond to the leading edge of the text element, utilizing optical character recognition (OCR) analysis; and
program instructions to identify a second word at edge coordinates of the text element that correspond to the trailing edge of the text element, utilizing OCR analysis.

12. (canceled)

13. The computer program product of claim 8, wherein the program instructions to determine the text at the leading edge of the text element depicted in the fixed layout version of the document and the text at the trailing edge of the text element depicted in the fixed layout version of the document, based on the determined edge coordinates, further comprise:
program instructions to identify at least two words at edge coordinates of the text element that correspond to the leading edge of the text element, utilizing optical character recognition (OCR) analysis; and
program instructions to identify at least two words second word at edge coordinates of the text element that correspond to the trailing edge of the text element, utilizing OCR analysis.

14. A computer system comprising:
one or more computer processors;
one or more computer readable storage media; and
program instructions stored on the computer readable storage media for execution by at least one of the one or more processors, the stored program instructions comprising:
program instructions to identify a document having a fixed layout version and a plain text version, wherein the fixed layout version is an image file and the plain text version is a text file;
program instructions to identify a visual anchor corresponding to a text element depicted in the fixed layout version of the document utilizing an edge detection analysis;
program instructions to determine edge coordinates of the text element depicted in the fixed layout version of the document;
program instructions to determine text at a leading edge of the text element depicted in the fixed layout version of the document and text at a trailing edge of the text element depicted in the fixed layout version of the document, based on the determined edge coordinates; and
program instructions to extract a complete version of the text element depicted in the fixed layout version of the document, from the plain text version of the document, utilizing the determined text at the leading edge of the text element and the determined text at the trailing edge of the text element, wherein the complete version of the text element includes the determined text at the leading edge of the text element, the determined text at the trailing edge of the text element, and one or more intervening words between the determined text at the leading edge of the text element and the determined text at the trailing edge of the text element.

15. The computer system of claim 14, wherein the visual anchor is a visual depiction of information in the fixed layout version of the document, selected from the group consisting of: one or more particular characters, one or more particular phrases, and one or more images.

16. (canceled)

17. The computer system of claim 14, wherein the program instructions to determine the text at the leading edge of the text element depicted in the fixed layout version of the document and the text at the trailing edge of the text element depicted in the fixed layout version of the document, based on the determined edge coordinates, further comprise:
program instructions to identify a first word at edge coordinates of the text element that correspond to the leading edge of the text element, utilizing optical character recognition (OCR) analysis; and
program instructions to identify a second word at edge coordinates of the text element that correspond to the trailing edge of the text element, utilizing OCR analysis.

18. (canceled)

19. The computer system of claim 14, wherein the program instructions to determine the text at the leading edge of the text element depicted in the fixed layout version of the document and the text at the trailing edge of the text element depicted in the fixed layout version of the document, based on the determined edge coordinates, further comprise:
program instructions to identify at least two words at edge coordinates of the text element that correspond to the leading edge of the text element, utilizing optical character recognition (OCR) analysis; and
program instructions to identify at least two words second word at edge coordinates of the text element that correspond to the trailing edge of the text element, utilizing OCR analysis.

20. The computer system of claim 14, further comprising program instructions, stored on the computer readable storage media for execution by at least one of the one or more processors, to:
convert the fixed layout version of the document into the plain text version of the document.

21. The method of claim 4, wherein extracting the complete version of the text element depicted in the fixed layout version of the document, from the plain text version of the document, utilizing the determined text at the leading edge of the text element and the determined text at the trailing edge of the text element, comprises:
analyzing, by one or more processors, the plain text version of the document to determine a text element of the plain text version of the document that is encompassed by the first word and the second word; and
identifying, by one or more processors, the determined text element of the plain text version of the document as the complete version of the text element based on one or more characteristics.

22. The method of claim 21, wherein the one or more characteristics include a number of words in the text element.

23. The method of claim 21, wherein the one or more characteristics include words in proximity of the text element.
